(19) United States
(12) Patent Application Publication
(10) Pub. No.: US 2006/0100861 A1
(43) Pub. Date: May 11, 2006

(54) Signal filtering

(75) Inventors: Dirk Jeroen Breebaart, Eindhoven (NL); Erik Gosuinus Schuijers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninkijkle phillips electronics n.v

(21) Appl. No.: 10/531,026

(22) PCT Filed: Apr. 22, 2003
(86) PCT No.: PCT/IB03/01660

§ 371 Date: Apr. 12, 2005

(30) Foreign Application Priority Data
Oct. 14, 2002 (EP) 02079303.0

(51) Int. Cl. G10L 19/14

(52) U.S. Cl. 704/205

(57) ABSTRACT

A method of filtering an information signal (x(t)), the method comprising modifying frequency domain components (X(k,n)) of the information signal according to a desired filter response (F(k,n)); wherein the step of modifying frequency domain components further comprises modifying (105) frequency domain components of a first frame of said information signal according to a first actual filter response (F′(k,n)), the first actual filter response being a function (Φ) of the desired filter response and information (108) related to a previous frame of the information signal.

This invention relates to the filtering of an information signal and, in particular, to the filtering of an information signal by modifying frequency domain components of the information signal according to a desired filter response.

In the field of signal processing, it is known to perform a filtering of an information signal, such as an audio signal, by segmenting the information signal using overlapping frames, transforming the frames into the frequency domain, modifying the frequency-domain components of the signal frame, inverse transforming the modified frequency-domain components back into the time domain, and performing an overlap-add operation (see e.g. Oppenheim & Shafer: “Discrete-time signal processing”, Prentice Hall signal processing series, 1989).

The above prior art involves the problem that the overlap-add operation of successive frames may result in undesirable artifacts, if the filtering step, i.e. the modification of the frequency-domain components, includes a processing with dynamically varying parameters, in particular with a varying phase. For example, it may happen that a certain frequency component adds in-phase for the overlap of two consecutive frames n and n+1, while the same components may be out-of-phase, if frame n+1 is compared to n+2. In the case of audio signals, these artifacts may result in unstable sound quality, e.g. modulations. In general, such artifacts may occur for any block-based implementation, i.e. an implementation where a filter transform is updated at a rate lower than the sample rate of the signal, thereby generating artifacts due to block-varying phases.

The above and other problems are solved by a method of filtering an information signal, the method comprising modifying frequency domain components of the information signal according to a desired filter response; wherein the step of modifying frequency domain components further comprises modifying frequency domain components of a first frame of said information signal according to a first actual filter response, the first actual filter response being a function of the desired filter response and information related to a previous frame of the information signal.

Hence, by modifying the frequency domain components of a current signal frame according to an actual filter response which is a function of the desired filter response and information related to a previous frame of the information signal, the filter response of a processing step is transformed taking a previous processing step into consideration. Consequently, artifacts due to phase changes across consecutive frames are efficiently reduced.

In general, the processing of a filter may be described by its filter response. In the frequency domain, the filter output for a given frequency component may be expressed as a corresponding input frequency component multiplied with a, in general complex, filter response or weight factor. The term desired filter response comprises the filter response or weight factors corresponding to the desired filter function. Methods for determining desired filter responses for a given filter are known in the art of signal processing (see e.g. Oppenheim & Shafer, “Discrete-time signal processing”, Prentice Hall signal processing series, 1989). The term actual filter response comprises the filter response actually applied to the input signal according to the invention.

In a preferred embodiment of the invention, the method further comprises

segmenting an information signal into a number of signal frames;

transforming the signal frames to obtain frequency domain components of the respective signal frames;

inverse transforming the modified frequency domain components to obtain filtered signal frames; and

performing a recombination operation of the filtered signal frames to obtain a filtered information signal.

Hence, an efficient filtering method is provided which reduces the amount of distortions introduced due to the filtering.

Preferably, the function of the desired filter response and information related to a previous frame is selected as to reduce artifacts introduced by the step of performing a recombination operation, thereby improving the perceptual quality of the information signal.

Here, the term recombination operation comprises any recombination technique for recombining the modified signal from the modified signal frames. Examples of such recombination operations comprise an overlap-add method, an overlap-save method, or the like.

The information related to a previous frame may comprise a filter response of a previous frame, the modified frequency components of a previous frame, or the like.

In a preferred embodiment, the information related to a previous frame comprises at least one of the actual filter response and the desired filter response of a previous frame of the information signal. Hence the actual filter response may be a function of the desired filter response of one or more previous frames and/or the actual filter response applied to one or more previous frames, thereby providing a method which may be adapted to a large variety of applications.

It is noted that the function may further depend on additional information, such as information about the current frame, e.g. a tonality measure of the current flame.

In another preferred embodiment, the step of modifying frequency domain components of a first frame further comprises

determining a desired filter response for the first frame;

determining the first actual filter response for the first frame as a function of the desired filter response and at least a second filter response related to a previous frame of the information signal; and

applying the determined actual first filter response to the first frame to obtain modified frequency domain components of the first frame.

It is further preferred that the function of the desired filter response and the second filter response is selected as to reduce phase changes of the filter response.

In a further preferred embodiment, the step of determining the first actual filter response comprises

determining a phase difference of a frequency component of the desired filter response for the first frame and a corresponding frequency component of the filter response of a previous frame;

determining a desired phase change as a function of the determined phase difference; and

determining a frequency component of the first actual filter response as the corresponding frequency component of the filter response of a previous frame modified by a phase change factor comprising the determined desired phase change.

Hence, a method is provided for efficiently limiting the phase change of the filter response between consecutive frames, thereby reducing perceptible artifacts in the resulting signal.

In a yet further preferred embodiment, the function of the determined phase difference is a cut-off function limiting the phase difference to be smaller than a predetermined threshold value. Hence a determination of the phase difference is provided that only requires little computational resources. Furthermore, as the threshold value may be selected according to the actual application, e.g. as a fixed value, a time and/or frequency dependant value, or the like, the method may be adapted to a variety of applications. Alternatively, other relations between the determined and the desired phase difference may be chosen, e.g. a soft-knee behavior provided by a saturated input-output function.

In a yet further preferred embodiment, said reduction of phase changes of the filter response is made dependant on a measure of tonality. For example, for a noise-like signal, phase jumps between consecutive samples may occur in the input signal. Limiting the phase difference for such samples may change the perceptual properties of the filtered signal in an undesired way. For example, in the case of audio signals, a noise-like signal would become more tonal which is often perceived as a synthetic or metallic sound. Hence by only—or at least predominantly—limiting the phase difference of signal frames having a high level of tonality, the above undesired effects may be reduced.

The present invention can be implemented in different ways including the method described above and in the following, an arrangement, and further product means, each yielding one or more of the benefits and advantages described in connection with the first-mentioned method, and each having one or more preferred embodiments corresponding to the preferred embodiments described in connection with the first-mentioned method and disclosed in the dependant claims.

It is noted that the features of the method described above and in the following may be implemented in software and carried out in a data processing system or other processing means caused by the execution of computer-executable instructions. The instructions may be program code means loaded in a memory, such as a RAM, from a storage medium or from another computer via a computer network. Alternatively, the described features may be implemented by hardwired circuitry instead of software or in combination with software.

The invention further relates to an arrangement for filtering an information signal, the arrangement comprising means for modifying frequency domain components of the information signal according to a desired filter response; wherein the means for modifying frequency domain components of the information signal comprises means for modifying frequency domain components of a first frame of said information signal according to a first actual filter response, the first actual filter response being a function of the desired filter response and information related to a previous frame of the information signal.

It is noted that the above arrangement including the means for modifying the frequency components may be implemented as general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

The invention further relates to an electronic device comprising such an arrangement. The term electronic device comprises any device suitable for the processing of an information signal. Examples of such devices comprise audio equipment including an audio decoder for decoding coded audio information, such as audio players, recorders, etc.

The invention further relates to a filtered information signal generated by the method described above and in the following. The filtered information signal may further be processed, e.g. coded according to a known coding scheme, such as an MPEG coding scheme.

The invention further relates to a storage medium having stored thereon such a filtered information signal.

Here, the term storage medium comprises but is not limited to a magnetic tape, an optical disc, a digital video disk (DVD), a compact disc (CD or CD-ROM), a mini-disc, a hard disk, a floppy disk, a ferro-electric memory, an electrically erasable programmable read only memory (EEPROM), a flash memory, an EPROM, a read only memory (ROM), a static random access memory (SRAM), a dynamic random access memory (DRAM), a synchronous dynamic random access memory (SDRAM), a ferromagnetic memory, optical storage, charge coupled devices, smart cards, a PCMCIA card, etc.

These and other aspects of the invention will be apparent and elucidated from the embodiments described in the following with reference to the drawing in which:

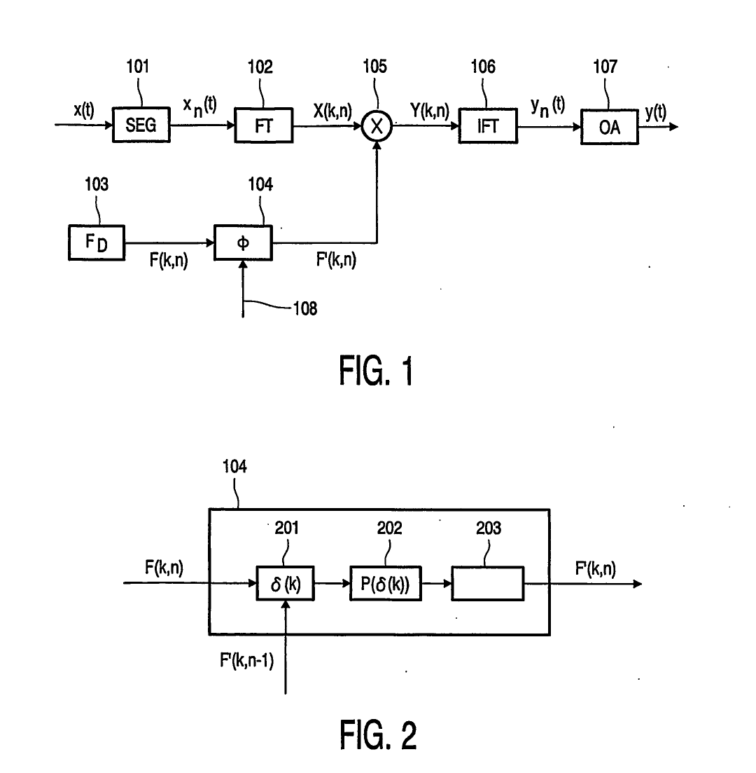

FIG. 1 illustrates a method of filtering an information signal according to an embodiment of the invention;

FIG. 2 illustrates an embodiment of the transformation of the filter response;

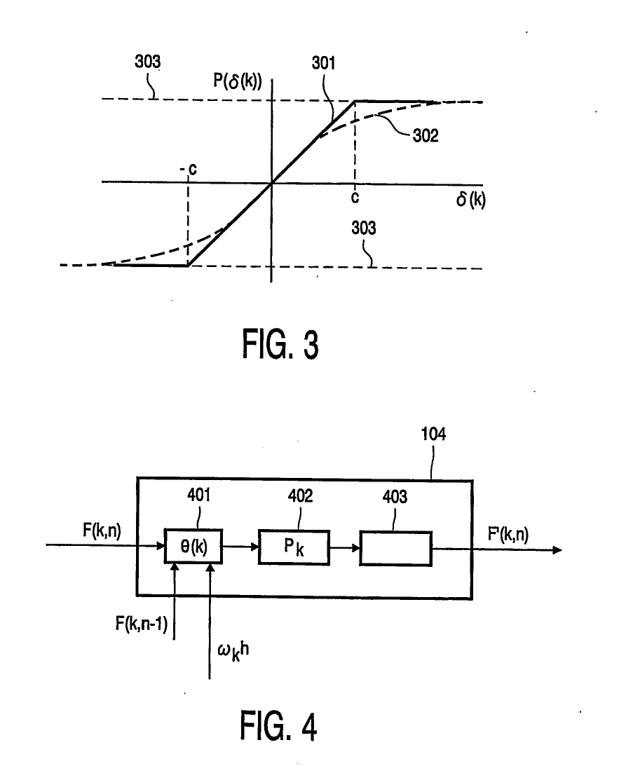

FIG. 3 illustrates examples of functional forms used in the embodiment of FIG. 2; and

FIG. 4 illustrates another embodiment of the transformation of the filter response.

FIG. 1 illustrates a method of filtering an information signal according to an embodiment of the invention. In an initial step 101, an incoming information signal x(t) is segmented into a number of frames. The incoming signal is assumed to be a suitably sampled waveform, e.g. representing an audio signal or the like. For example, in the case of an audio signal, t represents a discrete time. Therefore, we will refer to signals indexed by t as signals in the time domain. However, it is understood that, for other types of information signals, t may represent other coordinates, such as spatial coordinates. The segmentation step 101 splits the signal into frames xₙ(t) of a suitable length, for example in the range 500-5000 samples, e.g. 1024 or 2048 samples. Preferably, the segmentation is performed using overlapping window functions, thereby suppressing artefacts which may be introduced at the frame boundaries (see e.g. Princen, J. P., and Bradley, A. B.: “Analysis/synthesis filterbank design based on time domain aliasing cancellation”, IEEE transactions on Acoustics, Speech and Signal processing, Vol. ASSP 34, 1986).

In step 102, each of the frames xₙ(t) is transformed into the frequency domain by applying a Fourier transformation, preferably implemented as a Fast Fourier Transform (FFT). The resulting frequency representation of the n-th frame xₙ(t) comprises a number of frequency components X(k,n) where the parameter-n indicates the frame number and the parameter k indicates the frequency component or frequency bin corresponding to a frequency ωₖ, 0<k<K. In general, the frequency domain components X(k,n) are complex numbers.

In step 103, the desired filter for the current frame is determined. In many applications the calculation of the desired filter is performed adaptively, i.e. in response to predetermined properties of the incoming signal, or controlled by time-varying parameters, i.e. in response to other signals or parameters, or the like. For example, in the field of parametric audio coding a stereo signal is often synthesized from a coded mono signal and predetermined additional parameters, such as a correlation between the left and right channels, etc. During synthesis of the stereo signal, each channel is filtered according to the desired properties of the resulting stereo signal. In another example, received communications signals are often filtered according to estimated channel properties.

The desired filter is expressed as a desired filter response comprising a set of K complex weight factors F(k,n), 0<k<K, for the n-th frame. The filter response F(k,n) may be represented by two real numbers, i.e. its amplitude a(k,n) and its phase φ(k,n) according to
F(k,n)=a(k,n) exp[jφ(k,n)].

In the frequency domain, the filtered frequency components are Y(k,n)=F(k,n)·X(k,n), i.e. they result from a multiplication of the frequency components X(k,n) of the input signal with the filter response F(k,n). As will be apparent to a skilled person, this multiplication in the frequency domain corresponds to a convolution of the input signal frame xₙ(t) with a corresponding filter fₙ(t).

According to the invention, in step 104, the desired filter response F(k,n) is modified before applying it to the current frame X(k,n). In particular, the actual filter response F′(k,n) to be applied is determined as a function of the desired filter response F(k,n) and of information 108 about previous frames. Preferably, this information comprises the actual and/or desired filter response of one or more previous frames, according to

$${F}^{′} ( k , n ) = {a}^{′} ( k , n ) \cdot exp [ {jφ}^{ ′} ( k , n ) ] = Φ [ F ( k , n ) , F ( k , n - 1 ) , F ( k , n - 2 ) , … , {F}^{′} ( k , n - 1 ) , {F}^{′} ( k , n - 2 ) , … ] .$$

Hence, by making the actual filter response dependant of the history of previous filter responses, artifacts introduced by changes in the filter response between consecutive frames may be efficiently suppressed. Preferably, the actual form of the transform function Φ is selected to reduce overlap-add artifacts resulting from dynamically-varying filter responses.

For example, the transform function Φ may be a function of a single previous response function, e.g. F′(k,n)=Φ₁[F(k,n), F(k,n-1)] or F′(k,n)=Φ₂[F(k,n), F′(k,n-1)]. In another embodiment, the transform function may comprise a floating average over a number of previous response functions, e.g. a filtered version of previous response functions, or the like. Preferred embodiments of the transform function Φ will be described in greater detail below.

In step 105, the actual filter response F′(k,n) is applied to the current frame by multiplying the frequency components X(k,n) of the current frame of the input signal with the corresponding filter response factors F′(k,n) according to
Y(k,n)=F′(k,n)·X(k,n).

In step 106, the resulting processed frequency components Y(k,n) are transformed back into the time domain resulting in filtered frames yₙ(t). Preferably, the inverse transform is implemented as an Inverse Fast Fourier Transform (IFFT).

Finally, in step 107, the filtered frames are recombined to a filtered signal y(t) by an overlap-add method. An efficient implementation of such an overlap add method is disclosed in Bergmans, J. W. M.: “Digital baseband transmission and recording”, Kluwer, 1996.

FIG. 2 illustrates an embodiment of the transformation of the filter response. According to this embodiment, the transform function Φ of step 104 in FIG. 1 is implemented as a phase-change limiter between the current and the previous frame.

In step 201, the phase change δ(k) of each frequency component F(k,n) compared to the actual phase modification φ′(k,n-1) applied to the previous sample of the corresponding frequency component is computed, i.e.
δ(k)=φ(k,n)−φ′(k,n-1).

In step 202, the phase component of the desired filter F(k,n) is modified in such a way that the phase change across frames is reduced, if the change would result in overlap-add artifacts. According to this embodiment, this is achieved by ensuring that the actual phase difference does not exceed a predetermined threshold c, e.g. by simply cutting of the phase difference, according to

$$( k , n ) = \{ \begin{matrix}F ( k , n ) & if \vert δ ( k ) \vert < c \\ {F}^{′} ( k , n - 1 ) . {ⅇ}^{j . c . sign [ δ ( k ) ]} , & otherwise\end{matrix} \qquad ( 1 )$$

The threshold value c may be a predetermined constant, e.g. between π/8 and π/3 rad. In one embodiment, the threshold c may not be a constant but e.g. a function of time, frequency, and/or the like. Furthermore, alternatively to the above hard limit for the phase change, other phase-change-limiting functions may be used.

FIG. 3 illustrates examples of functional forms used in the embodiment of FIG. 2. In general, in the above embodiment, the desired phase-change across subsequent time frames for individual frequency components is transformed by an input-output function P(δ(k)) and the actual filter response F′(k,n) is given by
F′(k,n)=F′(k,n-1)·exp[j P(δ(k))]. (2)

Hence, according to this embodiment, a transform function P of the phase change across subsequent time frames is introduced.

FIG. 3 illustrates two examples of functional forms of the transform function P. The solid curve illustrates the hard limit described above, which limits the phase change to be smaller than the threshold c, as illustrated by the dotted lines 303. As an alternative to the above “hard-knee” input-output relation, a “soft-knee” input-output relation may be used as illustrated by the dashed line 302 in FIG. 3. Such a smooth transition may be implemented by a differentiable, monotonous function, e.g. P(x)=c tan h(αx), where c is the above threshold and the parameter a determines the slope of the curve.

Again referring to FIG. 2, in step 203, the actual filter response F′(k,n) is determined according to eqn. (2) above.

FIG. 4 illustrates another embodiment of the transformation of the filter response. According to this embodiment, the phase limiting procedure is driven by a suitable measure of tonality, e.g. a prediction method as described below. This has the advantage that phase jumps between consecutive frames which occur in noise-like signals may be excluded from the phase-change limiting procedure according to the invention. This is an advantage, since limiting such phase jumps in noise like signals would make the noise-like signal sound more tonal which is often perceived as synthetic or metallic.

According to the embodiment of FIG. 4, in step 401, a predicted phase error
θ(k)=φ(k,n)−φ(k,n-1)−ωₖ·h
is calculated. Here, ωₖ denotes the frequency corresponding to the k-th frequency component and h denotes the hop size in samples. Here, the term hop size refers to the difference between two adjacent window centers, i.e. half the analysis length for symmetric windows. In the following, it is assumed that the above error is wrapped to the interval [−π,+π].

In step 402, a prediction measure Pₖ for the amount of phase predictability in the k-th frequency bin is calculated according to
Pₖ=(π−|θ(k)|)/π∈[0,1],
where |·| denotes the absolute value.

Hence, the above measure Pₖ yields a value between 0 and 1 corresponding to the amount of phase-predictability in the k-th frequency bin. If Pₖ is close to 1, the underlying 5 signal may be assumed to have a high degree of tonality, i.e. has a substantially sinusoidal waveform. For such a signal, phase jumps are easily perceivable, e.g. by the listener of an audio signal. Hence, phase jumps should preferably be removed in this case. On the other hand, if the value of Pₖ is close to 0, the underlying signal may be assumed to be noisy. For noisy signals phase jumps are not easily perceived and may, therefore, be allowed.

Accordingly, in step 403, the phase limiting function is applied if Pₖ exceeds a predetermined threshold, i.e. Pₖ>A, resulting in the actual filter response F′(k,n). For example, a phase limiting function as described in connection with FIGS. 2 and 3 may be applied if Pₖ>A, according to

$${F}^{′} ( k , n ) = \{ \begin{matrix}F ( k , n ) & if {P}_{k} < A \\ {F}^{′} ( k , n - 1 ) \cdot {ⅇ}^{j \cdot P [ δ ( k ) ]} , & otherwise\end{matrix} .$$

Here, A is limited by the upper and lower boundaries of P which are +1 and 0, respectively. The exact value of A depends on the actual implementation. For example, A may be selected between 0.6 and 0.9.

It is understood that, alternatively, any other suitable measure for estimating the tonality may be used. In yet another embodiment, the allowed phase jump c described above may be made dependant on a suitable measure of tonality, e.g. the measure Pₖ above, thereby allowing for larger phase jumps if Pₖ is large and vice versa

It is noted that the above methods may be implemented by corresponding arrangements, e.g. implemented as general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof Hence, FIGS. 1, 2, and 4 above may be read as block diagrams of such arrangements.

It should further be noted that the above-mentioned embodiments illustrate rather than limit the invention, and that those skilled in the art will be able to design many alternative embodiments without departing from the scope of the appended claims.

It should further be noted that even though the invention has primarily been described in connection with an audio signal, the scope of the invention is not restricted to audio signals. It is understood that the invention may also be applied to other information signals, such as multimedia signals, video signals, animations, graphics, still images, or the like.

The method according to the invention may be applied to the filtering of a large variety of information signals. As an example, the method may be applied in the field of parametric stereo coding. As is known in the field of parametric stereo coding, in a decoder of such a coding system, two output signals are synthesized, both having time-varying phase modifications. Using the method according to the present invention, the inventors have observed a considerable improvement of the quality of the synthesized output signals of such a system.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of filtering an information signal, the method comprising modifying frequency domain components of the information signal according to a desired filter response; wherein the step of modifying frequency domain components further comprises modifying frequency domain components of a first frame of said information signal according to a first actual filter response, the first actual filter response being a function of the desired filter response and information; related to a previous frame of the information signal.

2. A method according to claim 1, wherein the method further comprises
segmenting an information signal into a number of signal frames;
transforming the signal frames to obtain frequency domain components of the respective signal frames;
inverse transforming the modified frequency domain components to obtain filtered signal frames; and
performing a recombination operation of the filtered signal frames to obtain a filtered information signal.

3. A method according to claim 2, wherein the function of the desired filter response and information related to a previous frame is selected as to reduce artifacts introduced by the step of performing a recombination operation.

4. A method according to claim 2, wherein the recombination operation comprises an overlap-add operation.

5. A method according to claim 1, wherein the information related to a previous frame is comprises at least one of the actual filter response and the desired filter response of a previous frame of the information signal.

6. A method according to claim 1, wherein the step of modifying frequency domain components of a first frame further comprises
determining a desired filter response for the first frame;
determining the first actual filter response for the first frame as a function of the desired filter response and at least a second filter response related to a previous frame of the information signal; and
applying the determined actual first filter response to the first frame to obtain modified frequency domain components of the first frame.

7. A method according to claim 6, wherein the step of determining the first actual filter response comprises
determining a phase difference of a frequency component of the desired filter response for the first frame and a corresponding frequency component of the filter response of a previous frame;
determining a desired phase change as a function of the determined phase difference; and
determining a frequency component of the first actual filter response as the corresponding frequency component of the filter response of a previous frame modified by a phase change factor comprising the determined desired phase change.

8. A method according to claim 7, wherein the function of the determined phase difference is a cut-off function limiting the phase difference to be smaller than a predetermined threshold value.

9. A method according to claim 6, wherein the function of the desired filter response and information related to a previous frame is selected to reduce phase changes of the filter response.

10. A method according to claim 9, wherein said reduction of phase changes of the filter response is made dependant on a measure of tonality.

11. A method according to claim 1, wherein the information signal is an audio signal.

12. An arrangement for filtering an information signal, the arrangement comprising means for modifying frequency domain components of the information signal according to a desired filter response; wherein the means for modifying frequency domain components of the information signal comprises means for modifying frequency domain components of a first frame of said information signal according to a first actual filter response, the first actual filter response being a function of the desired filter response and information related to a previous frame of the information signal.

13. An electronic device comprising an arrangement for filtering an information signal, the arrangement comprising means for modifying frequency domain components of the information signal according to a desired filter response; wherein the means for modifying frequency domain components of the information signal comprises means for modifying frequency domain components of a first frame of said information signal according to a first actual filter response, the first actual filter response being a function of the desired filter response and information related to a previous frame of the information signal.

14. A filtered information signal generated by a method of filtering an information signal, the method comprising modifying frequency domain components of the information signal according to a desired filter response; wherein the step of modifying frequency domain components further comprises modifying frequency domain components of a first frame of said information signal according to a first actual filter response, the first actual filter response being a function of the desired filter response and information related to a previous frame of the information signal.

15. A storage medium having stored thereon a information signal according to claim 14.
